(19) United States
(12) Patent Application Publication
(10) Pub. No.: US 2002/0176003 A1
(43) Pub. Date: Nov. 28, 2002

(54) Watermark reading kiosks

(76) Inventors: Phillip Andrew Seder, Portland, OR (US); Geoffrey B. Rhoads, West Linn, OR (US); William C. Hein III, Glenmoore, PA (US); Brian T. Maclntosh, Lake Oswego, OR (US)

Correspondence Address: DIGIMARC CORPORATION, 19801 SW 72ND AVENUE, SUITE 100, TUALATIN, OR, 97062, US

(21) Appl. No.: 10/121,433

(22) Filed: Apr. 11, 2002

Related U.S. Application Data
(63) Continuation-in-part of application No. 09/697,009, filed on Oct. 25, 2000.
(60) Provisional application No. 60/284,163, filed on Apr. 16, 2001.

(51) Int. Cl. G06F 9/00

(52) U.S. Cl. 348/207.1

(57) ABSTRACT

A kiosk for reading a digital watermark from a physical object (e.g., a printed document) can be used in various contexts, including retail systems designed to provide customers with product information; corporate greeting systems used to register or direct a visitor; computer terminals in public environments—such as cyber cafés—which can be used to access the Internet; and registration terminals at service centers, such as a copy center, that are used to request services or provide information. An illustrative kiosk may include a housing with a computer concealed inside. On the outside of the kiosk is an illuminated stage on which the user can place the object to be read. An image sensor (e.g., a webcam) captures an image of the object placed on the stage, and the computer processes the image to decode the watermark payload. The computer than responds to the user (e.g., via a display screen or audio transducer) with responsive information.

### RELATED APPLICATION DATA

This application is a continuation-in-part of application No. 60/284,163, filed Apr. 16, 2001.

This application is also a continuation-in-part of application Ser. No. 09/697,009, filed Oct. 25, 2000.

### FIELD OF THE INVENTION

The present invention relates to kiosks for capturing and decoding watermark patterns from physical objects, including printed media.

### BACKGROUND AND SUMMARY OF THE INVENTION

Digital watermarking is the science of encoding physical and electronic objects with plural-bit digital data, in such a manner that the data is essentially hidden from human perception, yet can be recovered by computer analysis. In physical objects, the data may be encoded in the form of surface texturing, or printing. Such marking can be detected from optical scan data, e.g., from a scanner or web cam. The present assignee's U.S. Pat. No. 6,122,403, and application Ser. No. 09/503,881, are illustrative of certain watermarking technologies.

Watermarking can be used to tag objects with a persistent digital identifier, and as such finds myriad uses. Some are in the reahn of encoding an object with data that serves to associate the object with a store of related data. For example, an image watermark may contain an index value that serves to identify a database record specifying (a) the owner's name; (b) contact information; (c) license terms and conditions, (d) copyright date, (e) whether adult content is depicted, etc., etc. (The present assignee's MarcCentre service provides such functionality.) Related are so-called “connected content” applications, in which a watermark in one content object (e.g., a printed magazine article) serves to link to a related content object (e.g., a web page devoted to the same topic). The watermark can literally encode an electronic address of the related content object, but more typically encodes an index value that identifies a database record containing that address information. Application Ser. No. 09/571,422 details a number of connected-content applications and techniques.

Copending application Ser. No. 09/697,009 discloses technology—including a reader station—by which a steganographic watermark pattern may be read from printing on a coffee cup, and used to trigger informational or promotional responses, and teaches that such reader stations can be provided at coffee shops.

Applicants have found that reliable capture and decoding of watermark data from physical objects can be a challenge in certain environments. Accordingly, the present invention was created to provide a reading station at which watermarked objects can be reliably read. The resulting kiosk finds application at trade shows, retail displays, access control points, and wherever watermarked media needs to be read.

The foregoing and additional features and advantages will be more readily apparent from the following detailed description, which proceeds with reference to the accompanying drawings.

### BRIEF DESCRIPTION OF THE DRAWINGS

FIG. 1 shows an arrangement employing a free-standing image sensor (e.g., camera) and stage, according to one embodiment of the invention.

FIG. 2 shows an arrangement employing an image sensor in a rotating jig, according to another embodiment of the invention.

FIG. 3 shows the arrangement of FIG. 2, with the image sensor pointed downwardly towards a fixed stage.

FIG. 4 shows icons that may be presented on a screen to a user of a kiosk to provide feedback on system operation.

### DETAILED DESCRIPTION

For expository convenience, the present disclosure makes reference to the present assignee's “MediaBridge Reader” software (available for free public download from www.digimarc.com) for capturing image data and decoding watermark information therefrom. Naturally, different such software can be employed as the application demands.

Kiosks include any hardware-based interactive environments where watermark reader software is used to direct a user to a Web site or to trigger a specific system response. Examples of kiosks include:

Retail systems designed to provide customers with product information

Corporate greeting systems used to register or direct a visitor

Computer terminals in public environments, such as a cyber café, which can be used to access the Internet

Registration terminals at service centers, such as a copy center, that are used to request services or provide information

In every case, the kiosk may be a highly specialized hardware system designed specifically for a particular use, or it can consist of off-the-shelf computer components with some customization. In either case, watermark reading software can be added along with a web camera to enable the kiosk to respond to watermarked items. These items can include special redemption coupons, prize materials, product packaging, special identification cards or even advertising.

Typical System Specifications

Windows 98, Windows 2000 or Windows Me

Internet Explorer 5.0 or later; Netscape 5.0 or later

128 MB RAM

10 GB hard disk space available

700 MHz Pentium III

1024×768 screen resolution

True (24-bit) color

Intel Pro PC Camera (e.g., with driver version 4.90.3000.1-4.100.0.54)

Touch-screen or keyboard to receive user input.

Environmental Considerations

This section provides an overview of things that should be considered in placement and setup of a watermark-reading kiosk.

Lighting

The lighting source and level in the kiosk should be constant. Lighting levels in the kiosk location should be uniformly maintained between 105 and 115 lux. The type and angle of lighting should be such that it does not shine directly into the kiosk camera, or cause glare in the camera lens; in addition, it should not cause glare on any objects that are held up to the camera. When possible, light sources that generates 5000K or “full spectrum” light should be employed. Finally, for best performance, the camera and/or kiosk should not be situated in the path of direct sunlight at any time of day.

Camera Placement

The camera is desirably installed in such a way that the end user is prevented from handling or adjusting it. When the camera is enclosed in a special mounting bracket or enclosure (“jig”), the jig may be placed so that the camera is kept safe from tampering, spills, etc. The camera should not be exposed to extreme temperatures, poor ventilation, extreme lighting conditions (excessively bright light to dim or no light) or movement. The camera may be mounted solidly in a level position, so that it will always be perpendicular to items being placed in front of it.

Depending on the kiosk environment and the characteristics of the items being read at the kiosk, many different jig configurations can be used. Regardless of which jig configuration is used, however, the optimal distance between the item being read and the camera lens should be maintained consistently by either providing a mount, holding container or platform (“stage”) for users to place their items on; a mechanical stop (outside of the camera's field of view) to guide users to the correct distance; or some type of visual guide with explicit instructions on how to hold an item up to the camera.

Free-Standing Camera

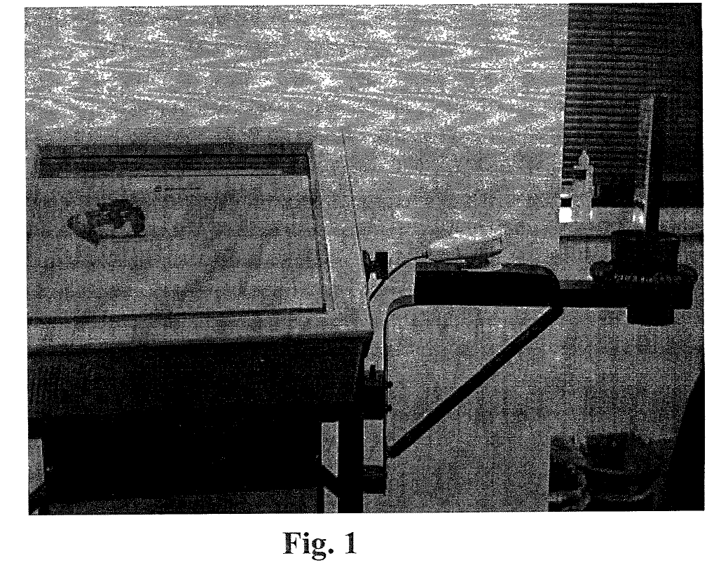

FIG. 1 shows a free-standing camera arrangement. Desirably, such a camera should be used with a mount or holder whose position can be easily set to the correct distance by the kiosk developer or maintenance person. Note that users should not be able to adjust the mount or holder position, to ensure that it will remain set to the optimal distance for the given kiosk application.

Camera in Rotating Jig

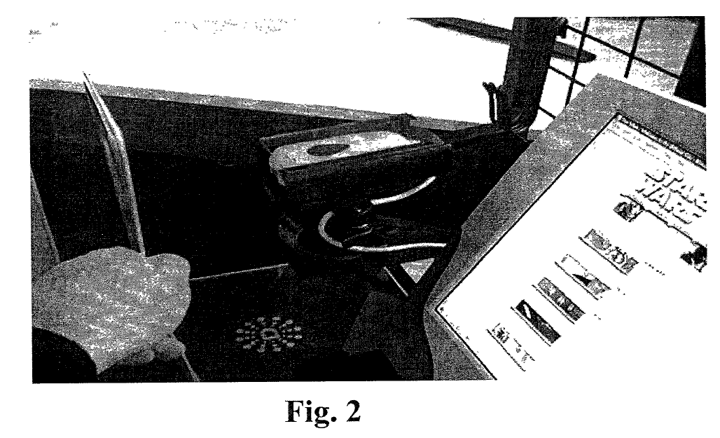

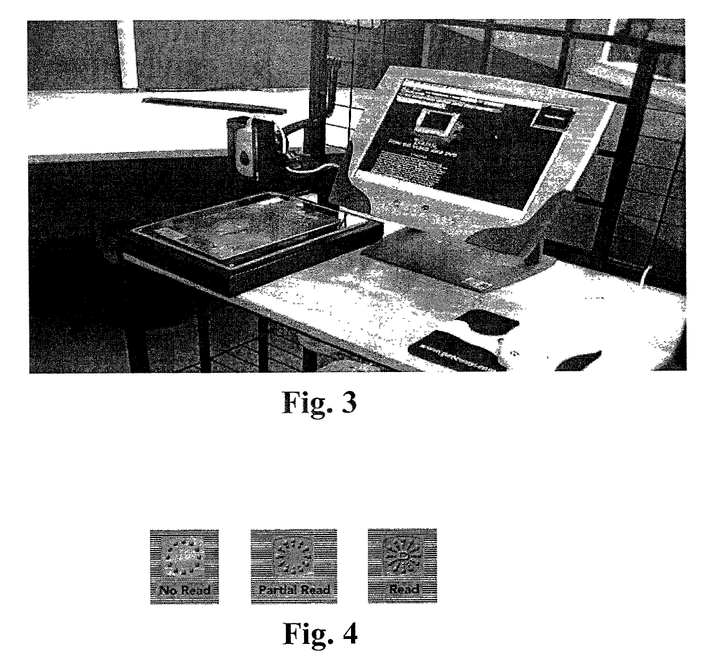

FIGS. 2 and 3 show arrangements in which the camera is provided on a platform that includes different degrees of freedom, e.g., rotation.

Mounting the camera in a rotating jig can be an effective approach for a kiosk in which the items are held up to the camera, placed in a vertical bay or holder or laid flat below the camera. The jig position may be adjustable so that it can be easily set by the developer or kiosk maintenance person to the correct distance. The vertically mounted, downward-aiming jig should be used only when all items to be read will be of a consistent thickness, so as to ensure that the correct distance will be maintained between item and camera—for example, a kiosk that will be used only with newspaper ads.

Camera Orientation

The camera focus should be preset with the target object fixed within 0.25″ of the recommended focal distance (3 or 5 inches depending upon the camera model). The kiosk is desirably arranged so that an item can easily be held steadily in front of the camera regardless of shape, size or weight. Depending on the item to be read, a positioning platform, slot or bay may create the best user experience by ensuring that the item to be read is placed in a stable position with proper distance and lighting. For example, Digimarc has designed a kiosk that successfully reads a coffee cup sleeve when the cup is placed in a cup holder built into the kiosk. The cup holder frees the end user from worrying about lighting, distance or stability.

In addition, the camera jig or kiosk bay should be designed so that the item to be read can easily be placed at the exact recommended distance from the camera regardless of shape, size or weight. This may entail allowing end users to hold their objects flat against a camera jig that houses the camera.

If the kiosk will possibly be used to read translucent materials such as newspaper, its design should include a backlighting shield in order to avoid bleedthrough of extraneous information and ensure maximum accuracy.

Camera View Visibility

The Camera View (i.e., the view seen by the camera is presented to the user on the screen) is a central component of the Digimarc MediaBridge Reader 2.0 software interface, as it helps the end user properly position the item in front of the camera. In most situations, it is an important element of a successful user experience with the Reader. However, there are special circumstances under which the Camera View may be omitted from a kiosk's software interface.

When a kiosk setting meets all of the following criteria, it's reasonable to consider hiding or eliminating the Camera View:

Items to be read are heavily watermarked on all sides/surfaces

Items to be read are of a consistent shape and size

The placement of an item in front of the camera is exact -in a bay or marked area

Instructions make it very clear to the end user how to place the item in or on the kiosk

The lighting is controlled and very consistent, with little or no time needed for adjustment

Users of the kiosk are familiar with its function and its proper use.

The Camera View should generally be visible when any of the following are applicable:

Items to be read are not heavily watermarked all over (signal strength is medium to weak) or are heavily marked only in specific areas

Items to be read are of varying shapes and sizes

Users must hold items up to the camera by hand, or the kiosk is built such that positioning in front of the camera is not exact

Users are instructed to hold a specific part of the item up to the camera

The lighting in the kiosk setting varies.

Whenever the Camera View is visible, it may appear in the upper left-hand corner of the screen, on top of or to the left of other kiosk applications. Desirably, it should never be covered by other screens or windows. The user should not be able to move the Camera View from its preset location.

Camera View icons

The Camera View icons that appear in the Digimarc MediaBridge Reader 2.0 (FIG. 4) may be used to help guide users when an object is not instantaneously read. If the standard icons from the Reader are used in the kiosk application, they should be used “as is,” including their labels. Static text explanations should be included, possibly as part of the use instructions; if an input device is being used in the kiosk, mouse rollovers are a possible alternative.

Sound

The Digimarc MediaBridge Reader automatically plays a sound when an item is successfully read, providing the end user with an audio cue. Although the audio cue can be disabled, it is a valuable source of end user feedback and is desirable in most setups.

To provide a comprehensive disclosure without unduly lengthening this specification, the patents and applications cited above are incorporated herein by referenced, together with copending application Ser. Nos. 09/503,881 and 09/452,023.

Having described and illustrated the subject technologies with reference to illustrative embodiments, it should be recognized that the invention is not so limited.

For example, while the detailed description focused on reading of digital watermarks, other visual symbologies (e.g., bar codes, glyphs) can be read using similar arrangements.

The implementation of the functionality described above (including watermark decoding) is straightforward to artisans in the field, and thus not further belabored here. Conventionally, such technology is implemented by suitable software, stored in long term memory (e.g., disk, ROM, etc.), and transferred to temporary memory (e.g., RAM) for execution on an associated CPU. In other implementations, the functionality can be achieved by dedicated hardware, or by a combination of hardware and software. Reprogrammable logic, including FPGAs, can advantageously be employed in certain implementations.

It should be recognized that the particular combinations of elements and features in the above-detailed embodiments are exemplary only; the interchanging and substitution of these teachings with other teachings in this and the incorporated-byreference patents/applications are also contemplated.

Having described and illustrated the subject technologies with reference to illustrative embodiments, it should be recognized that the invention is not so limited. Rather, we claim as our invention all such embodiments as come within the scope and spirit of the following, claims, and equivalents thereto.

We claim:

1. A kiosk for reading a digital watermark from a physical object, the kiosk comprising:
a housing;
a computer concealed within the housing;
a stage on which the user is directed to place the object;
a light source illuminating the stage; and
a camera including a 2D optical sensor, the camera having an output coupled to the computer and having a lens directed at the stage;
wherein the computer operates to receive image data from the camera, decode a watermark therefrom, and provide a response thereto.

2. The kiosk of claim 1 further including a display screen, the computer presenting at least a portion of said response on said display screen.

3. The kiosk of claim 1 in which the light source provides illumination of about 105 to 115 lux onto objects placed on the stage.

4. The kiosk of claim 1 in which the light source provides substantially full-spectrum illumination.

5. The kiosk of claim 1 in which the camera is mounted on a platform providing plural degrees of freedom.

6. The kiosk of claim 1 further including a display screen on which a camera view is displayed.

7. The kiosk of claim 1, including instructions thereon for instructing users as to placement of objects on the stage.
